(19) United States
(12) Patent Application Publication
(10) Pub. No.: US 2024/0344607 A1
(43) Pub. Date: Oct. 17, 2024

(54) PISTON RING WITH INTEGRATED ANTI-ROTATION FEATURE

(71) Applicant: Pratt & Whitney Canada Corp., Longueuil (CA)

(72) Inventor: Rabih Kassab, Pointe-Claire (CA)

(21) Appl. No.: 18/634,181

(22) Filed: Apr. 12, 2024

Related U.S. Application Data
(60) Provisional application No. 63/459,528, filed on Apr. 14, 2023.

(51) Int. Cl. F16J 9/24; F01D 11/00

(52) U.S. Cl. CPC F16J 9/24; F01D 11/003; F05D 2240/58

(57) ABSTRACT

A piston ring for use with a gas turbine engine, including: a circular body having a rectangular cross section with overlapping open free ends; and an anti-rotating feature extending from an axial surface of the circular body, the anti-rotating feature being integrally formed with the circular body such that the circular body and the anti-rotating feature are formed from a single unitary member.

### CROSS REFERENCE TO RELATED APPLICATIONS

The present application claims the benefit of U.S. Provisional Patent Application Ser. No. 63/459,528 filed Apr. 14, 2023, the entire contents of which are incorporated herein by reference thereto.

### BACKGROUND

This present disclosure relates to a piston ring for use in a gas turbine engine. More particularly, a piston ring with an integrated anti-rotation feature.

Piston rings are used in gas turbine engines to create an air seal barrier between different cavities where air pressure gradient needs to be maintained between them. The piston rings are received within grooves and are maintained in place by friction at axial and radial interfaces. Many factors play a role in opposite of the frictional forces and try to move the piston ring the groove in all directions (radially, axially and circumferentially), which may be due to vibrations and pressure fluctuations. Spinning or circumferential movement of the piston ring in the groove may damage piston ring and/or the components that are being sealed by the piston ring.

As such, it is desirable to prevent spinning or circumferential movement of a piston ring in a gas turbine engine.

### BRIEF DESCRIPTION

Disclosed is a piston ring for use with a gas turbine engine, including: a circular body having a rectangular cross section with overlapping open free ends; and an anti-rotating feature extending from an axial surface of the circular body, the anti-rotating feature being integrally formed with the circular body such that the circular body and the anti-rotating feature are formed from a single unitary member.

In addition to one or more of the features described above, or as an alternative to any of the foregoing embodiments, wherein the anti-rotating feature is located at one of the overlapping free ends such that an axial thickness of the one of the overlapping free ends is greater than the rectangular cross section of the circular body.

In addition to one or more of the features described above, or as an alternative to any of the foregoing embodiments, the axial surface of the circular body is opposite to an axial side of the piston ring that provides an axial sealing interface.

In addition to one or more of the features described above, or as an alternative to any of the foregoing embodiments, the anti-rotating feature is a plurality of anti-rotating features extending from the axial surface of the circular body.

In addition to one or more of the features described above, or as an alternative to any of the foregoing embodiments, one of the plurality of anti-rotating features is located at one of the overlapping free ends.

In addition to one or more of the features described above, or as an alternative to any of the foregoing embodiments, the axial surface of the circular body is opposite to an axial side of the piston ring that provides an axial sealing interface.

Also disclosed is a seal assembly for use in a gas turbine engine, including: a first inner cylindrical component; a second outer cylindrical component; a groove located in the first inner cylindrical component or the second outer cylindrical component; the groove defined by a seal side rail that extends radially away from a surface of the first inner cylindrical component or a surface of the second outer cylindrical component and a non-seal side rail that extends radially away from the surface of the first inner cylindrical component or the surface of the second outer cylindrical component, the seal side rail and the non-seal rail being in a facing spaced relationship; and a piston ring located in the groove between the first inner cylindrical component and the second outer cylindrical component, the piston ring being located between the seal side rail and the non-seal side rail, the piston ring having a circular body with a rectangular cross section with overlapping open free ends, and an anti-rotating feature extending from an axial surface of the circular body, the anti-rotating feature being integrally formed with the circular body such that the circular body and the anti-rotating feature are formed from a single unitary member, wherein the anti-rotating feature is received within a slot formed in the non-seal side rail and contact between the anti-rotating feature and the slot prevents circumferential movement of the piston ring in the groove.

In addition to one or more of the features described above, or as an alternative to any of the foregoing embodiments, the slot extends from or up to an upper surface of the non-seal side rail so that the anti-rotating feature can be received in a radial direction in the slot as the piston ring is radially inserted to the groove and the slot is configured to allow for thermal expansion of the piston ring.

In addition to one or more of the features described above, or as an alternative to any of the foregoing embodiments, the anti-rotating feature is located at one of the overlapping free ends such that an axial thickness of the one of the overlapping free ends is greater than the rectangular cross section of the circular body.

In addition to one or more of the features described above, or as an alternative to any of the foregoing embodiments, the axial surface of the circular body is opposite to an axial side of the piston ring that provides an axial sealing interface with the seal side rail and a combined axial thickness of the piston ring and anti-rotating feature is greater than or equal to a combined axial thickness of the groove and the slot.

In addition to one or more of the features described above, or as an alternative to any of the foregoing embodiments, the anti-rotating feature is a plurality of anti-rotating features extending from the axial surface of the circular body and the slot is a plurality of slots formed in the non-seal side rail each of the plurality of anti-rotating features being received within a respective one of the plurality of slots formed in the non-seal side rail.

In addition to one or more of the features described above, or as an alternative to any of the foregoing embodiments, one of the plurality of anti-rotating features is located at one of the overlapping free ends.

In addition to one or more of the features described above, or as an alternative to any of the foregoing embodiments, the axial surface of the circular body is opposite to an axial side of the piston ring that provides an axial sealing interface with the seal side rail.

In addition to one or more of the features described above, or as an alternative to any of the foregoing embodiments, the first inner cylindrical component is a bearing housing cover and the second outer cylindrical component is a housing slid over the piston ring.

In addition to one or more of the features described above, or as an alternative to any of the foregoing embodiments, the first inner cylindrical component is a bearing housing cover and the second outer cylindrical component is a housing slid over the piston ring.

Also disclosed is a method for providing a seal in a gas turbine engine, including: inserting a piston ring between a first inner cylindrical component and a second outer cylindrical component, the piston ring having a circular body with a rectangular cross section with overlapping open free ends, and an anti-rotating feature extending from an axial surface of the circular body, the anti-rotating feature being integrally formed with the circular body such that the circular body and the anti-rotating feature are formed from a single unitary member, wherein a groove is located in the first inner cylindrical component or the second outer cylindrical component, the groove defined by a seal side rail that extends radially away from a surface of the first inner cylindrical component or a surface of the second outer cylindrical component and a non-seal side rail that extends radially away from the surface of the first inner cylindrical component or the surface of the second outer cylindrical component, the seal side rail and the non-seal rail being in a facing spaced relationship; and preventing circumferential movement of the piston ring within the groove by locating the anti-rotating feature within a slot formed in the non-seal side rail such that contact between the anti-rotating feature and the slot prevents circumferential movement of the piston ring in the groove.

In addition to one or more of the features described above, or as an alternative to any of the foregoing embodiments, the slot extends from or up to an upper surface of the non-seal side rail so that the anti-rotating feature can be received in a radial direction in the slot as the piston ring is radially inserted to the groove.

In addition to one or more of the features described above, or as an alternative to any of the foregoing embodiments, the anti-rotating feature is located at one of the overlapping free ends.

In addition to one or more of the features described above, or as an alternative to any of the foregoing embodiments, the axial surface of the circular body is opposite to an axial side of the piston ring that provides an axial sealing interface with the seal side rail.

In addition to one or more of the features described above, or as an alternative to any of the foregoing embodiments, the anti-rotating feature is a plurality of anti-rotating features extending from the axial surface of the circular body and the slot is a plurality of slots formed in the non-seal side rail each of the plurality of anti-rotating features being received within a respective one of the plurality of slots formed in the non-seal side rail.

### BRIEF DESCRIPTION OF THE DRAWINGS

The following descriptions should not be considered limiting in any way. With reference to the accompanying drawings, like elements are numbered alike:

FIG. 1 is a schematic, partial cross-sectional view of a gas turbine engine in accordance with this disclosure;

FIG. 2 schematically illustrates a portion of a mid-turbine frame of a gas turbine engine;

FIG. 3 is perspective view of a piston ring configured for use with a gas turbine engine;

FIG. 3A is an enlarged portion of the piston ring illustrated in FIG. 3;

FIG. 4 is a cross-sectional view of a seal formed by a piston ring located between a first inner cylindrical component and a second outer cylindrical component;

FIG. 5 is a perspective view of a portion of a piston ring located between within a cylindrical component in accordance with the present disclosure;

FIG. 6 is another perspective view of a portion of a piston ring located between within a cylindrical component in accordance with the present disclosure;

FIG. 7 is yet another perspective view of a portion of a piston ring located between within a cylindrical component in accordance with the present disclosure; and

FIG. 8 is a partial cross-sectional perspective view of a piston ring located between a first inner cylindrical component and a second outer cylindrical component.

### DETAILED DESCRIPTION

A detailed description of one or more embodiments of the disclosed apparatus and method are presented herein by way of exemplification and not limitation with reference to the FIGS.

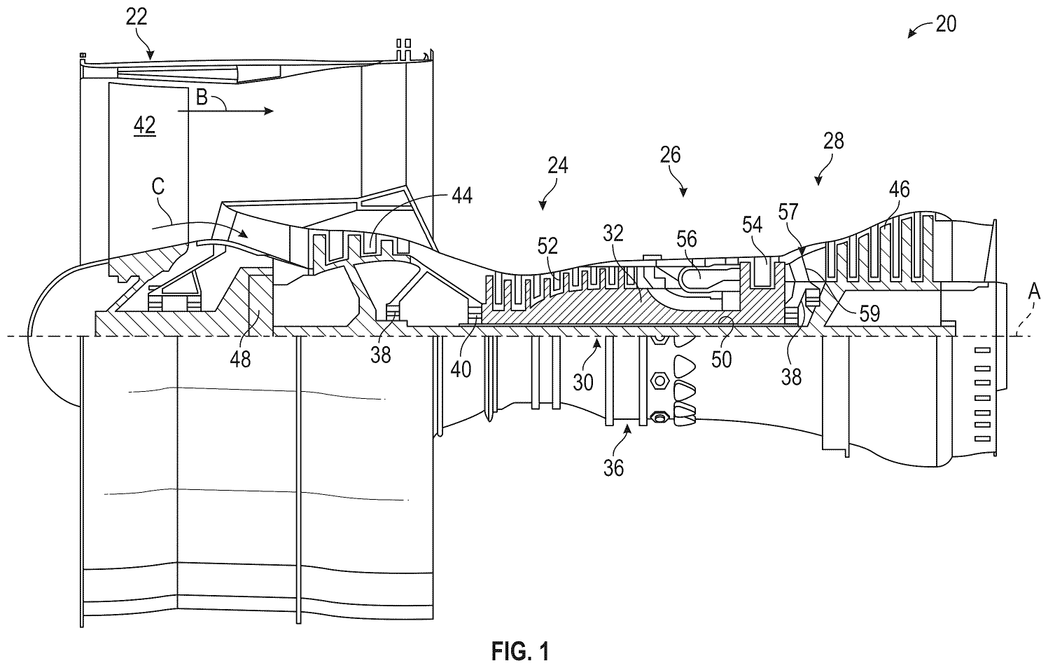

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include other systems or features. The fan section 22 drives air along a bypass flow path B in a bypass duct, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a first or low pressure compressor 44 and a first or low pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a second or high pressure compressor 52 and a second or high pressure turbine 54. A combustor 56 is arranged in exemplary gas turbine 20 between the high pressure compressor 52 and the high pressure turbine 54. A mid-turbine frame 57 of the engine static structure 36 is arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The mid-turbine frame 57 includes airfoils 59 which are in the core airflow path C. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 illustrated in FIG. 1 is merely exemplary and the present disclosure is contemplated for use with any type of engine or any other gas turbine engine including those that do not have a gear system 48 (e.g., a non-geared turbofan engine).

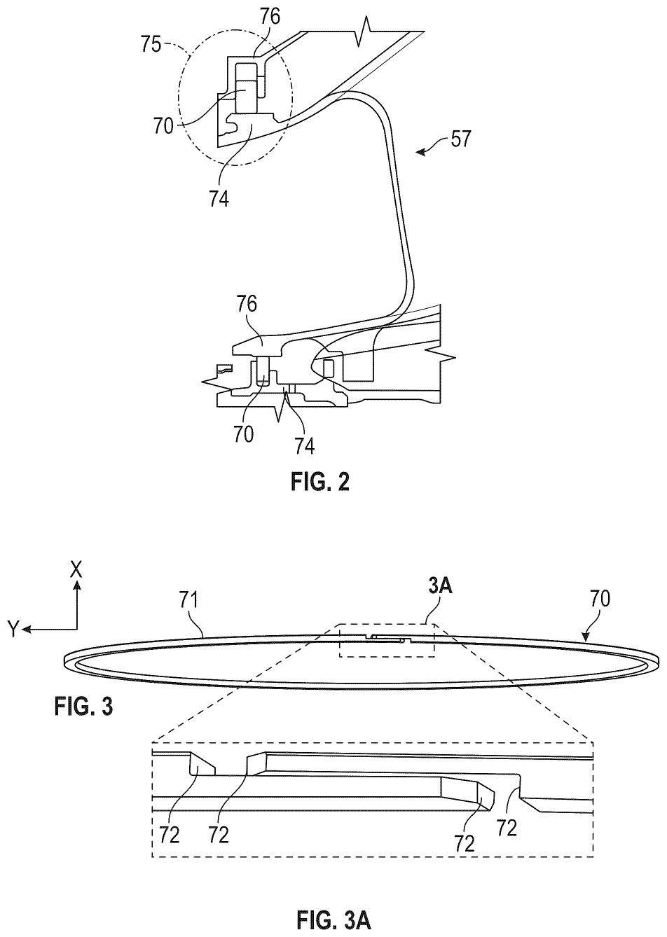

Referring now to FIG. 2 a portion of the mid-turbine frame 57 is illustrated. As illustrated, a piston ring 70 is used to an air seal barrier between different cavities where air pressure gradient needs to be maintained between them. Piston rings are used in turbines to create the aforementioned air seal barriers although it is understood, that the piston ring configuration of the present disclosure may be used in other locations of the engine where the aforementioned air seal barriers are required.

Referring now to at least FIGS. 1-3, the piston ring 70 has a circular configuration or body 71 with open ends 72 and a rectangular cross section. As illustrated, the ends 72 are overlapping to provide better sealing capability.

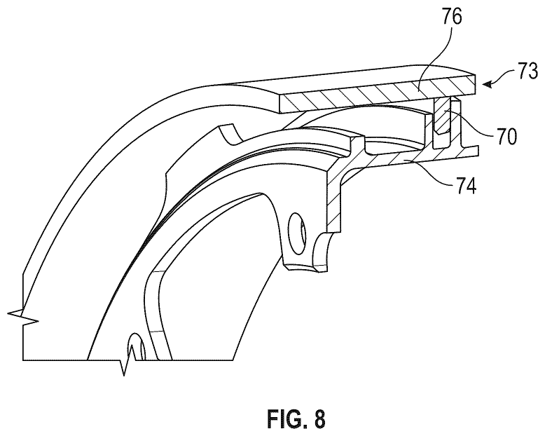

The piston rings 70 are installed between two concentric cylindrical portions of two components. For example, a first inner cylindrical component 74 surrounded by a second outer cylindrical component 76. As used herein the first inner cylindrical component 74 is radially inward of the second outer cylindrical component 76. As used herein, the first inner cylindrical component 74, the second outer cylindrical component 76, and the piston ring 70 may be referred to as a seal assembly 73. See at least FIG. 8. In one non-limiting embodiment, the first inner cylindrical component 74 may be a bearing housing cover and the second outer cylindrical component 76 may be a housing slid over the piston ring 70.

Referring now to at least FIGS. 1-4, one of the first inner cylindrical component 74 and the second outer cylindrical component 76 contains a groove 78 to contain the piston ring 70 and the other of the first inner cylindrical component 74 and the second outer cylindrical component 76 contains a smooth surface 80 for contact with the piston ring 70. The groove 78 is defined by a seal side wall or a seal side rail 82 that extends radially away from a surface 84 of the first inner cylindrical component 74 or alternatively surface 80 the second outer cylindrical component 76 and a non-seal side wall or a non-seal side rail 86 that extends radially away from the surface 84 of the first inner cylindrical component 74 or alternatively the surface 80 of the second outer cylindrical component 76. As illustrated, the seal side wall or seal side rail 82 and the non-seal side wall or non-seal rail 86 are in a facing spaced relationship so that the piston ring 70 can be received therebetween. The area 75 in FIG. 2 illustrates the configuration where the groove 78 is defined by a seal side wall or a seal side rail 82 and a non-seal side wall or a non-seal side rail 86 that extend radially away from the surface 80 of the second outer cylindrical component 76.

The piston ring 70 provides two sealing interfaces: an axial sealing interface 88 between an axial side 90 of the piston ring 70 with a surface of the seal side wall or seal side rail 82 at a lower pressure side 92 of the seal provided by the piston ring 70 and a radial interface 94. The radial interface 94 is provided by an outer radius or outer radial surface 96 of the piston ring 70 when the groove 78 is located on the first inner cylindrical component 74. Alternatively, the radial interface 94 is provided by an inner radius or inner radial surface 98 of the piston ring 70 when the groove 78 is located on the second outer cylindrical component 76.

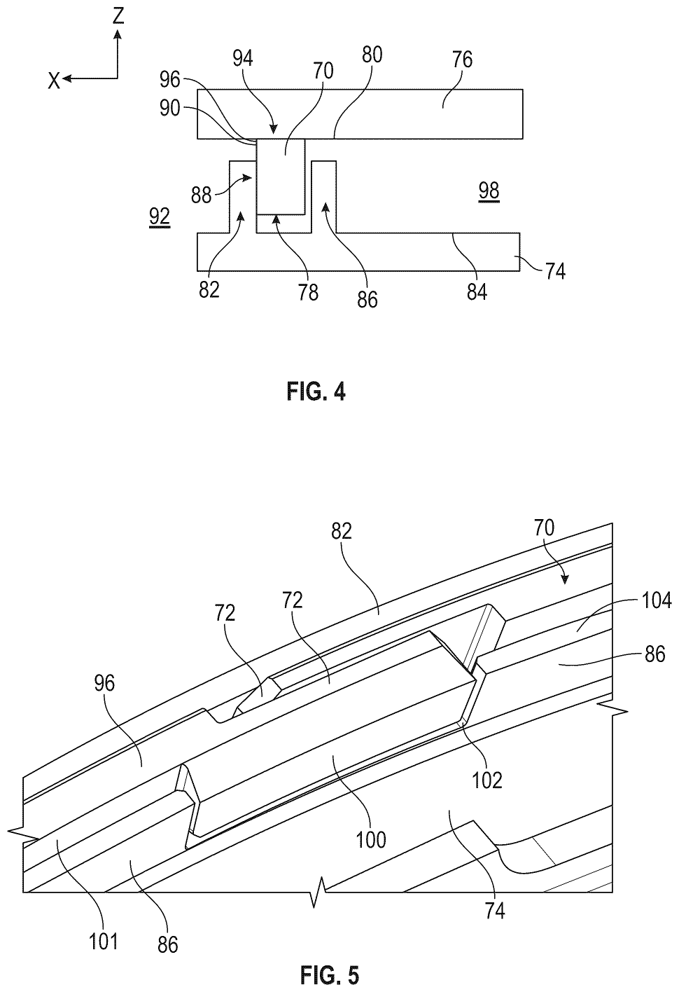

As used herein, axial (X), circumferential (Y) and radial (Z) refer to the directions illustrated in at least FIGS. 3 and 4. Also, radial directions (Z) may be referred to as distances with respect to the engine axis A illustrated in FIG. 1 and circumferential (Y) directions may be referred to as circular directions about the engine axis A illustrated in FIG. 1 or the circumferential direction of the piston ring 70.

The sealing provided by the piston ring 70 with the axial interface 88 is achieved by the pressure gradient between the lower pressure side 92 with respect to a higher pressure side 98 keeping the two faces of the piston ring 70 and the seal side rail or wall 82 together at the axial interface 88.

The sealing provided by the piston ring 70 with the radial interface 94 is achieved by the pressure created by the piston ring spring effect: e.g., in tension for inner sealing interface and in compression for outer sealing interface. In other words, the piston ring 70 is compressed prior to being inserted into the groove 78 illustrated in at least FIG. 4 and the piston ring 70 is expanded prior to being inserted into the groove 78 if it was provided on the second outer cylindrical component 76.

As such, the piston ring 70 is maintained in place by friction at the axial and radial interfaces. However, many factors play a role in opposite of the frictional forces and try to move the piston ring in the groove in all directions (radially, axially and circumferentially) most importantly vibrations and pressure fluctuations.

The moving piston ring creates fretting and surfaces damages as well as spinning of the piston ring in the groove 78.

Referring now to at least FIGS. 5-8 and in accordance with the present disclosure, the piston ring 70 is provided with an anti-rotating component or feature 100 to prevent the spinning of the piston ring 70. The anti-rotating component or feature 100 extends from an axial side 101 of the piston ring 70 that is opposite to an axial side of the piston ring 70 that provides the axial interface 88. The anti-rotating component or feature 100 is configured to be received within an anti-rotating slot or slot 102 formed in the non-seal side rail or non-seal side wall 86 forming groove 78. Since the anti-rotating component or feature 100 extends from the axial side 101 of the piston ring 70, side walls of the anti-rotating component or feature 100 will contact side walls of the anti-rotating slot 102 in order to prevent circumferential movement or spinning of the piston ring 70 when it is received within the groove 78 and the anti-rotating component or feature 100 is received within an anti-rotating slot 102. In other words, an axial thickness of the piston ring 70 where the anti-rotating component or feature 100 is located is greater than an axial thickness of the groove 78 between the seal side wall or the seal side rail 82 and the non-seal side wall or the non-seal side rail 86. In other words, the anti-rotating component or feature 100 must be received within the anti-rotating slot 102 in order to place the piston ring 70 in the groove 78. In yet another non-limiting embodiment, the axial thickness of the piston ring 70 where the anti-rotating component or feature 100 is located is greater than or equal to an axial thickness of the groove 78 between the seal side wall or the seal side rail 82 and the non-seal side wall or the non-seal side rail 86 plus the axial thickness of the anti-rotating slot 102 or the axial thickness of the non-seal side wall or the non-seal side rail 86. In other words and in this non-limiting embodiment, the axial thickness of the piston ring 70 where the anti-rotating component or feature 100 is located is at least the same as the axial thickness of the groove 78 and the axial thickness of the anti-rotating slot 102.

The anti-rotating slot 102 extends from or up to an upper surface 104 of the non-seal side rail or non-seal side wall 86 so that the anti-rotating component or feature 100 can be received in the radial direction in the anti-rotating slot 102 as the piston ring 70 is radially inserted to the groove 78. In other words, the anti-rotating slot 102 is open at the top and no material of the non-seal side rail or non-seal side wall 86 extends over the top of the anti-rotating slot 102.

In one embodiment and as illustrated in at least FIG. 5, the anti-rotating component or feature 100 is located proximate to the distal end of one of the overlapping ends 72 of the piston ring 70. The anti-rotating component or feature 100 is integrally formed with the piston ring 70 such that it and the piston ring 70 are formed as a single component. In other words, the anti-rotating component or feature 100 is formed as a single piece with the piston ring 70. In one non-limiting embodiment, the anti-rotating component or feature 100 is formed by reducing the axial thickness of the piston ring 70 but leaving the material behind that will comprise the anti-rotating component or feature 100. As such, the anti-rotating component or feature 100 is an integral portion of the piston ring (e.g., formed as a single unitary component). In one embodiment, the size of the slot or the anti-rotating slot 102 is large enough to allow for the required thermal expansion and/or contraction and eccentricity of the piston ring 90 between the first inner cylindrical component 74 and the second outer cylindrical component 76 as well as any thermal expansions and contractions of the first inner cylindrical component 74 and the second outer cylindrical component 76 during operation of the engine 20 (e.g., heating and cooling of the engine 20) so that the anti-rotating component or feature 100 can operate as intended. For example and if the piston ring 70 is formed from a different material than the first inner cylindrical component 74 and the second outer cylindrical component 76 their respective coefficients of expansion and contraction may be different. As such, the slot or the anti-rotating slot 102 should be configured to accommodate for the required thermal expansion and eccentricity between the first inner cylindrical component 74 and second outer cylindrical component 76 as well as the piston ring 70 during engine operation. In other words, the size of the slot or the anti-rotating slot 102 should be large enough to allow for the required thermal expansion and eccentricity between the inner component and outer component as well as the piston ring 70 during operation.

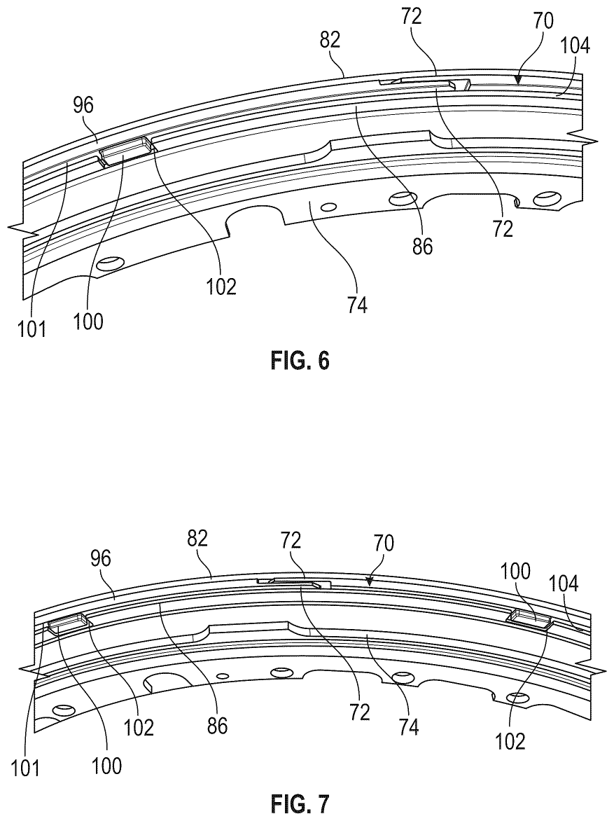

In addition and in yet another non-limiting embodiment, the piston ring 70 may comprises several anti-rotating components or features 100 that are received within corresponding anti-rotating slots 102. See at least FIGS. 6 and 7. In addition and as illustrated in at least FIG. 6, the anti-rotating component or feature 100 need not be located at one of the distal ends of the piston ring 70. In another alternative, one at least one or more than one anti-rotating component or feature 100 can be positioned on one side or on opposite sides about the overlap of the piston ring ends 72. In yet another alternative, the anti-rotating component or feature 100 or at least one of the anti-rotating components or features 100 can be located approximately ½ way between the piston ring ends 72.

Alternatively, one anti-rotating component or feature 100 is located at the overlap of the piston ring ends 72 and at least one other anti-rotating component or feature 100 is located away from the overlap of the piston ring ends 72.

FIG. 8 is a partial cross-sectional perspective view of a piston ring 70 located between the first inner cylindrical component 74 and the second outer cylindrical component 76.

In accordance with the present disclosure, the piston ring 70 is configured to include at least one anti-rotating component or feature 100 extending from and integrated with the piston ring 70 to prevent its spinning in the groove 78 and reduce damage to the piston ring 70 and of the sealed components (e.g., the first inner cylindrical component 74 and/or the second outer cylindrical component 76).

As mentioned above, the piston ring 70 may be configured with multiple anti-rotating components or features 100. The anti-rotating component or feature 100 may be located at the overlapping features of the piston ring 70 to strengthen thinner regions of the piston ring 70 at the overlap.

In addition and by providing an anti-rotating slot 102 that extends from or up to an upper surface 104 of the non-seal side rail or non-seal side wall 86 stresses at the interface between the non-seal side rail or non-seal side wall 86 and the anti-rotating component or feature 100 are reduced as the radial top of the anti-rotating slot 102 is open.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A piston ring for use with a gas turbine engine, comprising:
a circular body having a rectangular cross section with overlapping open free ends; and
an anti-rotating feature extending from an axial surface of the circular body, the anti-rotating feature being integrally formed with the circular body such that the circular body and the anti-rotating feature are formed from a single unitary member.

2. The piston ring as in claim 1, wherein the anti-rotating feature is located at one of the overlapping free ends such that an axial thickness of the one of the overlapping free ends is greater than the rectangular cross section of the circular body.

3. The piston ring as in claim 1, wherein the axial surface of the circular body is opposite to an axial side of the piston ring that provides an axial sealing interface.

4. The piston ring as in claim 1, wherein the anti-rotating feature is a plurality of anti-rotating features extending from the axial surface of the circular body.

5. The piston ring as in claim 4, wherein one of the plurality of anti-rotating features is located at one of the overlapping free ends.

6. The piston ring as in claim 5, wherein the axial surface of the circular body is opposite to an axial side of the piston ring that provides an axial sealing interface.

7. A seal assembly for use in a gas turbine engine, comprising:
a first inner cylindrical component;
a second outer cylindrical component;
a groove located in the first inner cylindrical component or the second outer cylindrical component, the groove defined by a seal side rail that extends radially away from a surface of the first inner cylindrical component or a surface of the second outer cylindrical component and a non-seal side rail that extends radially away from the surface of the first inner cylindrical component or the surface of the second outer cylindrical component, the seal side rail and the non-seal rail being in a facing spaced relationship; and
a piston ring located in the groove between the first inner cylindrical component and the second outer cylindrical component, the piston ring being located between the seal side rail and the non-seal side rail, the piston ring having a circular body with a rectangular cross section with overlapping open free ends, and an anti-rotating feature extending from an axial surface of the circular body, the anti-rotating feature being integrally formed with the circular body such that the circular body and the anti-rotating feature are formed from a single unitary member, wherein the anti-rotating feature is received within a slot formed in the non-seal side rail and contact between the anti-rotating feature and the slot prevents circumferential movement of the piston ring in the groove.

8. The seal assembly as in claim 7, wherein the slot extends from or up to an upper surface of the non-seal side rail so that the anti-rotating feature can be received in a radial direction in the slot as the piston ring is radially inserted to the groove and the slot is configured to allow for thermal expansion of the piston ring.

9. The seal assembly as in claim 7, wherein the anti-rotating feature is located at one of the overlapping free ends such that an axial thickness of the one of the overlapping free ends is greater than the rectangular cross section of the circular body.

10. The seal assembly as in claim 7, wherein the axial surface of the circular body is opposite to an axial side of the piston ring that provides an axial sealing interface with the seal side rail and a combined axial thickness of the piston ring and anti-rotating feature is greater than or equal to a combined axial thickness of the groove and the slot.

11. The seal assembly as in claim 7, wherein the anti-rotating feature is a plurality of anti-rotating features extending from the axial surface of the circular body and the slot is a plurality of slots formed in the non-seal side rail each of the plurality of anti-rotating features being received within a respective one of the plurality of slots formed in the non-seal side rail.

12. The seal assembly as in claim 11, wherein one of the plurality of anti-rotating features is located at one of the overlapping free ends.

13. The seal assembly as in claim 12, wherein the axial surface of the circular body is opposite to an axial side of the piston ring that provides an axial sealing interface with the seal side rail.

14. The seal assembly as in claim 13, wherein the first inner cylindrical component is a bearing housing cover and the second outer cylindrical component is a housing slid over the piston ring.

15. The seal assembly as in claim 7, wherein the first inner cylindrical component is a bearing housing cover and the second outer cylindrical component is a housing slid over the piston ring.

16. A method for providing a seal in a gas turbine engine, comprising:
inserting a piston ring between a first inner cylindrical component and a second outer cylindrical component, the piston ring having a circular body with a rectangular cross section with overlapping open free ends, and an anti-rotating feature extending from an axial surface of the circular body, the anti-rotating feature being integrally formed with the circular body such that the circular body and the anti-rotating feature are formed from a single unitary member, wherein a groove is located in the first inner cylindrical component or the second outer cylindrical component, the groove defined by a seal side rail that extends radially away from a surface of the first inner cylindrical component or a surface of the second outer cylindrical component and a non-seal side rail that extends radially away from the surface of the first inner cylindrical component or the surface of the second outer cylindrical component, the seal side rail and the non-seal rail being in a facing spaced relationship; and
preventing circumferential movement of the piston ring within the groove by locating the anti-rotating feature within a slot formed in the non-seal side rail such that contact between the anti-rotating feature and the slot prevents circumferential movement of the piston ring in the groove.

17. The method as in claim 16, wherein the slot extends from or up to an upper surface of the non-seal side rail so that the anti-rotating feature can be received in a radial direction in the slot as the piston ring is radially inserted to the groove.

18. The method as in claim 16, wherein the anti-rotating feature is located at one of the overlapping free ends.

19. The method as in claim 16, wherein the axial surface of the circular body is opposite to an axial side of the piston ring that provides an axial sealing interface with the seal side rail.

20. The method as in claim 19, wherein the anti-rotating feature is a plurality of anti-rotating features extending from the axial surface of the circular body and the slot is a plurality of slots formed in the non-seal side rail each of the plurality of anti-rotating features being received within a respective one of the plurality of slots formed in the non-seal side rail.
